(19) United States
(12) Patent Application Publication
(10) Pub. No.: US 2019/0312949 A1
(43) Pub. Date: Oct. 10, 2019

(54) Prefetch cache management using header modification

(71) Applicant: TENSERA NETWORKS LTD., Hod Hasharon (IL)

(72) Inventors: David Ben Eli, Modiin (IL); Navot Goren, Kibbutz Ramot Menashe (IL); Daniel Yellin, Raanana (IL); Roee Peled, Givatayim (IL); Shimon Moshavi, Beit Shemesh (IL)

(21) Appl. No.: 16/314,866

(22) PCT Filed: Oct. 19, 2017
(86) PCT No.: PCT/IB2017/056492

§ 371 Date: Jan. 3, 2019

Related U.S. Application Data
(60) Provisional application No. 62/412,864, filed on Oct. 26, 2016.
(60) Provisional application No. 62/567,267, filed on Oct. 3, 2017.

(51) Int. Cl. H04L 29/08; G06F 12/0862

(52) U.S. Cl. CPC H04L 67/2847; H04L 67/22; G06F 12/0862

(57) ABSTRACT

An apparatus (24, 60) includes a network interface (64) and one or more processors (44, 68). The network interface is configured for communicating over a communication network (32). The one or more processors are configured to prefetch content items over the communication network, from a content source (28) to a cache memory (52) of a user device (24), wherein at least a content item among the content items includes a cache directive specified by the content source, to modify the cache directive specified by the content source, and to serve the content item having the modified cache directive to a user application (36) running in the user device, so as to cause the user application to process the content item responsively to the modified cache directive.

### CROSS-REFERENCE TO RELATED APPLICATIONS

This application claims the benefit of U.S. Provisional Patent Application 62/412,864, filed Oct. 26, 2016, and U.S. Provisional Patent Application 62/567,267, filed Oct. 3, 2017, whose disclosures are incorporated herein by reference.

### FIELD OF THE INVENTION

The present invention relates generally to prefetching of content to user devices, and particularly to methods and systems for prefetch cache management.

### BACKGROUND OF THE INVENTION

Various techniques are known in the art for prefetching content to user devices. For example, U.S. Patent Application Publication 2016/0021211, whose disclosure is incorporated herein by reference, describes a method for content delivery that includes defining a guaranteed prefetching mode, in which content is continuously prefetched from a content source to a communication terminal of a user so as to maintain the communication terminal synchronized with the content source. One or more time-of-day intervals, during which the user is expected to access given content, are identified. During the identified time-of-day intervals, the given content is prefetched from the content source to the communication terminal using the guaranteed prefetching mode.

### SUMMARY OF THE INVENTION

An embodiment of the present invention that is described herein provides an apparatus including a network interface and one or more processors. The network interface is configured for communicating over a communication network. The one or more processors are configured to prefetch content items over the communication network, from a content source to a cache memory of a user device, wherein at least a content item among the content items includes a cache directive specified by the content source, to modify the cache directive specified by the content source, and to serve the content item having the modified cache directive to a user application running in the user device, so as to cause the user application to process the content item responsively to the modified cache directive.

In some embodiments, the cache directive is specified in a header of a message of an application-layer protocol in which the content item is prefetched, and the processors are configured to modify the cache directive by modifying the header. In an embodiment, the application-layer protocol is the Hypertext Transfer Protocol (HTTP). In an example embodiment, the cache directive is selected from a group consisting of “max-age,” “expires” timestamp, “no-store” and “no-cache.” In some embodiments, the cache directive specified by the content source indicates that the content item is not up-to-date, and the processors are configured to modify the cache directive to indicate that the content item is up-to-date. In some embodiments, the processors are configured to modify the cache directive only while operating in a guaranteed prefetching mode, and not while operating in a best-effort prefetching mode. In an embodiment, the processors are configured to decide whether to modify the cache directive based, at least in part, on whether a current prefetching mode is a guaranteed prefetching mode or a best-effort prefetching mode. In another embodiment, the processors are configured to present the prefetched content item to a user, and in parallel verify over the communication network whether the presented content item is up-to-date. In a disclosed embodiment, the processors are configured to track changes to the content item on the content source, and to modify the cache directive based on the tracked changes.

In an embodiment, at least one of the processors is a processor of the user device. In an example embodiment, the processors are configured to modify the cache directive using, at least in part, a software component running in an operating system of the user device. In an embodiment, at least one of the processors is a processor of a network-side node external to the user device. In an example embodiment, the processors are configured to modify the cache directive using, at least in part, a software component running in the network-side node. In an embodiment, the processors are configured to modify the cache directive by removing the cache directive or removing at least part of a header of a message carrying the content item. In another embodiment, the processors are configured to modify the cache directive by replacing the cache directive or replacing at least part of a header of a message carrying the content item. In yet another embodiment, the processors are configured to modify the cache directive by adding, to a header of a message carrying the content item, a “no-store” or “no-cache” cache directive.

In some embodiments, the processors are configured to modify the cache directive before caching the prefetched content item in the cache memory of the user device. In other embodiments, the processors are configured to modify the cache directive while the prefetched content item resides in the cache memory of the user device. In yet other embodiments, the processors are configured to modify the cache directive upon retrieving the prefetched content item from the cache memory of the user device for serving to the user application.

There is additionally provided, in accordance with an embodiment of the present invention, a method including prefetching content items over a communication network, from a content source to a cache memory of a user device. At least a content item among the content items includes a cache directive specified by the content source. The cache directive specified by the content source is modified, and the content item having the modified cache directive is served to a user application running in the user device, so as to cause the user application to process the content item responsively to the modified cache directive.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a content delivery system, in accordance with an embodiment of the present invention; and

FIG. 2 is a flow chart that schematically illustrates a method for content prefetching, in accordance with an embodiment of the present invention.

### DETAILED DESCRIPTION OF EMBODIMENTS

### Overview

Embodiments of the present invention that are described herein provide improved methods and systems for content delivery to user devices. In particular, the disclosed techniques improves the processing of cached content by user applications.

In some embodiments, a user device runs one or more user applications (“apps”) that consume content items provided by one or more content sources over a communication network. In order to reduce latency and improve user experience, a content delivery system prefetches selected content items over the network to a cache memory of the user device.

For at least some of the content items, the content source specifies cache directives that instruct the user device how to handle caching of the content items. Cache directives are specified, for example, by the Internet Engineering Task Force (IETF), in “Hypertext Transfer Protocol (HTTP/1.1): Caching,” Request for Comments (RFC) 7234, June, 2014, which is incorporated herein by reference. One type of cache directive specifies, for example, a maximal age by which a cached content item is still considered up-to-date and thus usable. Another type of cache directive specifies an expiry time, after which a cached content item is considered stale and unusable. The cache directives specified in RFC 7234 are sent in the headers of the HTTP responses that deliver the content items from the content source to the user device.

When a user application (“app”) requests a certain content item, the requested content item is typically served to the app together with the HTTP response header that possibly comprises one or more cache directives. The app then typically processes the content item in accordance with the cache directives, if specified. For example, if a directive indicates that the content item is up-to-date, the app would typically consume it, e.g., display the content to the user. If a directive indicates that the content item is not up-to-date, the app would typically request an up-to-date version of the content item from the content source, or at least send a request to the content source in order to re-evaluate the validity of the content item.

In some cases, the content delivery system has more accurate information regarding the validity of cached content items than the information conveyed by the cache directives specified by the content source. For example, a content item may be cached in the user device with an expiry-time directive that has elapsed long ago. The content delivery system, however, may have more accurate information indicating that the content item is in fact up-to-date, i.e., still identical to the most up-to-date version available on the content source.

In some embodiments, the content delivery system overrides the cache directives when appropriate, so that user apps act upon the more accurate information available. In an embodiment, the content delivery system comprises a header modification module that modifies the HTTP headers of selected content items to reflect the more accurate validity information. The content item having the modified header is served to the app, and the app in turn processes the content item in accordance with the modified header.

In this manner, the header modification module causes the app to process the content item in accordance with the accurate validity information available to the content delivery system, rather than in accordance with the cache directive or directives specified by the content source. At the same time, all communication between the app and the content delivery system is compliant with the existing application-layer protocol (e.g., HTTP) without requiring any modification on the app side.

The header modification module may modify headers in any suitable way, e.g., by extending the expiry time or maximal age specified in the cache directives, or by deleting specified cache directives altogether. As another example, the header modification module may add a “no-store” cache directive to the header, in order to indicate to the app that it should refrain from caching the content item internally.

The header modification module may be implemented in the user device and/or in a network-side node of the content delivery system, such as in a cloud server. The header modification module may modify the header of a content item at various stages of the content delivery process, e.g., before the content item is placed in the cache memory, after the content item is retrieved from the cache memory and before it is served to the app, or while the content item resides in the cache memory.

The disclosed techniques enables the user device to serve content items locally from the cache, in scenarios that would have otherwise necessitated re-fetching or re-validating content items over the network. As such, the disclosed techniques reduce the average latency of content delivery, enhancing user experience, and also help to reduce the user device's operating costs and power consumption.

### System Description

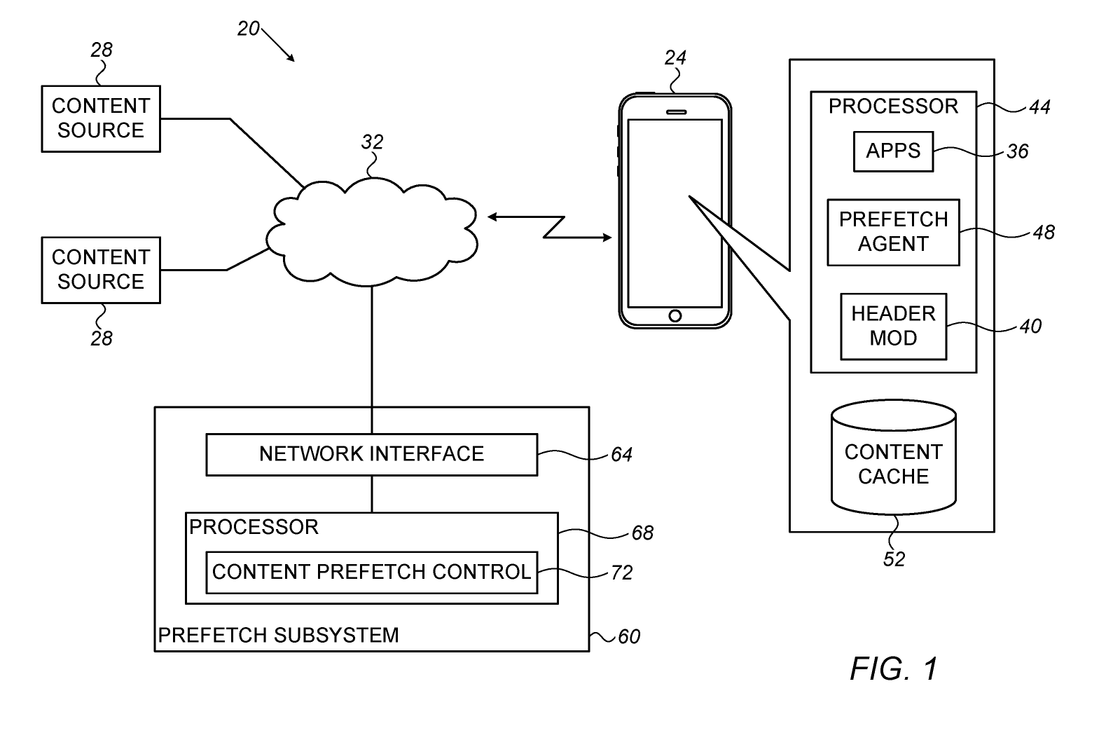

FIG. 1 is a block diagram that schematically illustrates a content delivery system 20, in accordance with an embodiment of the present invention. System 20 comprises a user device 24 that accesses and consumes content items provided by one or more content sources 28 over a network 32. Device 24 may comprise any suitable wireless or wireline device, such as, for example, a cellular phone, car mobile phone or smartphone, a wireless-enabled laptop or tablet computer, a desktop personal computer, a smart television set (TV), a wearable device, or any other suitable type of user device that is capable of communicating over a network and presenting content to a user.

User device 24 may consume content using any suitable software, e.g., using various user applications (“apps”) 36, or using a general-purpose browser. In the present context, a browser is also considered a type of user app. The figure shows a single user device 24 for the sake of clarity. Real-life systems typically comprise a large number of user devices of various kinds.

Network 32 may comprise, for example a Wide Area Network (WAN) such as the Internet, a Local Area Network (LAN), a wireless network such as a cellular network or Wireless LAN (WLAN), or any other suitable network or combination of networks.

Content sources 28 may comprise, for example, Web content servers, or any other suitable sources of content. The disclosed techniques can be used with any suitable types of content items, such as, for example, Web pages, audio or video clips, html files, java scripts and/or CSS files, to name just a few examples.

In some embodiments, system 20 performs prefetching of content items to user device 24. In the present example, user device 24 comprises a processor 44 that carries out the various processing tasks of the user device. Among other tasks, processor 44 runs user apps 36, and further runs a software component referred to as a prefetch agent 48 that handles prefetching of content items for apps 36. In addition, user device 24 comprises a content cache 52 for caching prefetched content items. Cache 52 is typically managed by prefetch agent 48.

Typically, prefetch agent 48 receives prefetched content items and stores them in content cache 52. Prefetch agent 48 may intercept user requests to access content items, and determine whether a requested item already resides in the cache. If so, the prefetch agent may retrieve the requested content item from the content cache. Otherwise, the prefetch agent would typically retrieve the requested content item from content sources 28 over network 32. In an embodiment, prefetch agent 48 may also assist in tracking historical usage patterns, and other relevant data related to the user device, which can be used as inputs for specifying prefetch policies for content.

User device 24 typically also comprises a suitable network interface (not shown in the figure) for connecting to network 32. This network interface may be wired (e.g., an Ethernet Network Interface Controller—NIC) or wireless (e.g., a cellular modem or a Wi-Fi modem). Typically, user device 24 further comprises some internal memory (not shown in the figure) that is used for storing relevant information, such as the applicable prefetch policy.

In the present example, processor 44 further runs a software module referred to as a header modification module 40. Module 40 modifies headers of selected application-protocol (e.g., HTTP) responses, so as to modify cache directives specified by content sources 28. The functionality of module 40 is addressed in detail below. As also elaborated below, the configuration in which header modification module 40 resides in user device 24 is one example configuration. Alternatively, the functions of module 40 may be carried out at least in part by any other element or elements of system 20.

In the embodiment of FIG. 1, system 20 further comprises a prefetching subsystem 60 that performs the various content prefetching related tasks on the network side. Subsystem 60 comprises a network interface 64 for communicating over network 32, and a processor 68 that helps carry out the various processing tasks of the prefetching subsystem. In the present example, processor 68 runs a Content Prefetching Control unit (CPC) 72 that carries out content prefetching.

In an example embodiment, CPC 72 defines a prefetch policy, which specifies how content is to be prefetched to user device 24. For example, CPC 72 may determine which content items are to be prefetched from content sources 28 to content cache 52, e.g., based on the likelihood that the user will request the content items. The CPC may determine the appropriate time for prefetching content items, e.g., based on a prediction of the time the user is expected to request them, and/or availability of communication resources. The CPC may determine how content items are to be delivered to cache 52, e.g., over a Wi-Fi or cellular connection. As yet another example, the CPC may determine the format with which content items are to be delivered to the user device, e.g., whether and how to perform compression or to deliver only changes for the case of content already prefetched (i.e., differential prefetch updates).

In various embodiments, as part of applying the prefetch policy, CPC 72 may estimate, for each content item, the likelihood that the user of user device 24 will request access to the content item. Such likelihood metrics can be sent to user device 24, and may be used by prefetch agent 48 in ranking prefetch priorities for the different content items. The likelihood estimation in CPC 72 may take into account various factors. Some factors may be user-related (e.g., gender, geographical location, interests, and/or recent and historical Internet activity). Other factors may be environment-related (e.g., time-of-day, road traffic conditions, weather, current events, and/or sporting occasions). Yet other factors may be content-related (e.g., content topic or category, content keywords, identity of the content source, and/or the current popularity or rating of the content).

In some embodiments, CPC 72 estimates the time the user is likely to access a content item in order to help determine the prefetch priorities of the various content items and/or the timing of the prefetch. These time estimates might be separately specified as part of the prefetch policy sent to the device, or they might be incorporated into likelihood metrics themselves. For example, a content item that is likely to be accessed within one hour might be given a higher likelihood metric than a content item that will not be needed for at least two hours.

Additionally or alternatively to the likelihood of the user accessing the content, other factors that CPC 72 may consider in specifying the prefetch policy may comprise power consumption considerations (e.g., preference to prefetch while a Wi-Fi connection or a strong cellular connection is available), transmission cost considerations (e.g., preference to lower-cost data transfer times), network congestion and server load considerations (e.g., preference to prefetch during off-peak traffic hours), and/or other user-related or network-related considerations.

Further additionally or alternatively, in specifying the prefetch policy, CPC 72 may associate certain times-of-day with respective prefetch priority levels. This association may be performed separately for different apps or content sources, or jointly for multiple apps or content sources. One example factor in determining the prefetch priority levels is the estimated likelihood of the user accessing the different apps or content sources during various times-of-day. Assigning a high priority to a prefetch operation typically translates to the prefetch operation being likely to occur (possibly conditioned on certain constraints or limitations).

Certain aspects of content prefetching, and content prefetching schemes that can be used by subsystem 60 and agent 48, are addressed in U.S. Patent Application Publication 2016/0021211, cited above. For example, CPC 72 may choose between various prefetching modes, e.g., a guaranteed prefetching mode and a best-effort prefetching mode. In the guaranteed prefetching mode, CPC 72 continuously tracks changes in content on content sources 28 (e.g., at predefined tracking intervals) and ensures that content cache 52 in user device 24 is regularly updated by prefetching to be synchronized with the content sources (e.g., at predefined guaranteed-mode prefetching intervals). In the best-effort mode, the CPC typically performs prefetching only as feasible using the available resources.

For example, in the best-effort mode, prefetching may be restricted to scenarios in which the user device's modem is active anyhow, scenarios in which a particularly robust network connection exists, or scenarios that involve a non-metered connection (e.g., Wi-Fi but not cellular). The guaranteed prefetching mode may be utilized during one or more time-of-day intervals in which the likelihood of a user accessing a content source has been predicted to be high. Other considerations that can affect the choice between the guaranteed and best-effort modes can be based on various prefetching policy considerations, e.g., power consumption, transmission cost, network congestion and/or server load. The choice of mode can also be made separately for different applications and/or content sources.

In some embodiments, CPC 72 regularly monitors content sources 28 and generates a “prefetch catalog”—a catalog of content items available for prefetching. Each content item is represented in the catalog by an identifier (ID) and a version number indication. The version numbers enable CPC 72 and/or prefetch agent 48 to determine, for example, whether a certain content item has changed relative to the version cached in cache 52 of user device 24. The catalog may also comprise the likelihood metrics described above, links or addresses from which the content items can be retrieved, and/or any other relevant information. The catalog is considered part of the prefetch policy, along with any other prefetch rules, strategies, thresholds or other policy matters defined by CPC 72.

The configurations of system 20 and its various elements shown in FIG. 1 are example configurations, which are chosen purely for the sake of conceptual clarity. In alternative embodiments, any other suitable configurations can be used. For example, the functions of prefetching subsystem 60, agent 48 and module 40 can be implemented using any desired number of processors, or even in a single processor. The various functions of subsystem 60, agent 48 and module 40 can be partitioned among the processors in any suitable way. In another embodiment, some or all of the functions of subsystem 60 may be performed by agent 48 in user device 24.

As another example, prefetch agent 48 and/or header modification module 40 may be implemented in a software module running on processor 44, in an application running on processor 44, in a Software Development Kit (SDK) embedded in an application running on processor 44, by the Operating System (OS) running on processor 44, or in any other suitable manner. In an embodiment, processor 44 may run a proxy server, which is controlled by prefetch agent 48 and is exposed to incoming and outgoing traffic.

Further alternatively, the functionality of prefetch agent 48 and/or header modification module 40 can be implemented entirely on the network side without an agent on user device 24. Further alternatively, some of the functionality of prefetch agent 48 and/or header modification module 40 can be implemented on the user-device side, and other functionality of prefetch agent 48 and/or header modification module 40 can be implemented on the network side. For example, a cloud-based prefetch server may track content items on content source 28, and report changes in content to a prefetch agent in the user device (possibly residing in the user device operating system).

Generally, the functions of the different systems elements described herein (e.g., prefetch agent, header modification module, content sources and elements of subsystem 60) can be partitioned in any other suitable way. Thus, in the context of the present patent application and in the claims, the disclosed techniques are carried out by one or more processors. The processors may reside in user device 24, and/or on the network side such as in subsystem 60 and/or in content sources 28.

Although the embodiments described herein refer mainly to human users, the term “user” refers to machine users, as well. Machine users may comprise, for example, various host systems that use wireless communication, such as in various Internet-of-Things (IoT) applications.

The different elements of system 20 may be implemented using suitable software, using suitable hardware, e.g., using one or more Application-Specific Integrated Circuits (ASICs) or Field-Programmable Gate Arrays (FPGAs), or using a combination of hardware and software elements. Cache 52 may be implemented using one or more memory or storage devices of any suitable type. In some embodiments, agent 48, module 40 and/or subsystem 60 may be implemented using one or more general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Controlling the Processing of Cached Content by User Applications Using Header Modification

In some embodiments, apps 36 in user device 24 request content items by sending HTTP requests to content sources 28. Content sources send the requested content items in respective HTTP responses. In these embodiments, prefetch agent 48 and prefetch subsystem 60, too, prefetch content items using HTTP requests and responses. HTTP is just one example of an application-layer protocol that can be used for delivering content. In alternative embodiments, the disclosed techniques can be used with any other suitable application-layer protocol that supports cache directives for delivered content. The description that follows, however, focuses on HTTP for the sake of clarity.

When delivering a requested content item, a content source 28 may specify one or more cache directives that instruct user device 24 how to handle caching of the content items. The cache directives are specified in suitable fields in the header of the HTTP response that delivers the content item. Some examples of cache directives, in accordance with RFC 7234, cited above, include:
“Max-age”—A directive that specifies the maximum time duration, from the time of the request for the content item, that the content item will be considered fresh (up-to-date, and thus usable).
“Expires”—A directive specifying an expiry time (typically date and time-of-day) at which the content item will cease being considered fresh.
“No-cache”—A directive that specifies that if the content item is cached, it should be re-validated with the originating content source before it is reused.
“No-store”—A directive that specifies that nothing regarding the HTTP response should be cached, including the returned content item.

When a user app 36 requests a certain content item, the requested content item is typically served to the app (either locally from cache 52 or over network 32) together with the HTTP response header that possibly comprises cache directives. The app then typically processes the content item in accordance with the cache directives. Thus, when prefetching a content item, prefetch agent 48 typically stores the HTTP response header of that item in cache 52 together with the content, so that the header can be served to the app.

For some content items that are cached in cache 52 of user device 24, system 20 may have more accurate information regarding validity than the information conveyed by the cache directives specified by content source 28. This improved knowledge may originate, for example, from a process of tracking changes to content on content sources 28 (e.g., crawling) performed by prefetch subsystem 60. The information may be provided to subsystem 60 and/or to agent 48 using any suitable means, such as over network 32, or from another user device over a direct device-to-device link between the user devices.

For example, the HTTP response header of a certain content item in cache 52 may comprise an “Expires” directive with an expiry time that has already passed, or a “Max-age” directive with an age that was already exceeded. Prefetch subsystem 60 or prefetch agent 48, on the other hand, may possess information indicating that the content item is actually fresh (i.e., identical to the most up-to-date version available on content source 28).

In such cases, prefetch subsystem 60 or prefetch agent 48 may trigger header modification module 40 to modify the HTTP response header of the content item in question. When triggered, module 40 modifies the HTTP response header such that the cache directives (or the lack thereof) indicate that the content item is up-to-date.

The content item having the modified header is served from cache 52 to app 36. The app will thus process the content item in accordance with the modified cache directives, instead of the original cache directives specified by the content source. For example, when the modified header indicates that the content item is up-to-date, the app will typically consume it and not request re-validation vis-à-vis the content source or re-fetching over the network.

In various embodiments, header modification module 40 may modify the header of a cached content item in various ways, to reflect the fact that the content item is still up-to-date and cause app 36 to continue using it.

For example, module 40 may increase the “Max-age” value in the HTTP response header to an age that has not yet passed, even though the “Max-age” value in the original header has passed already. As another example, module 40 may modify the “Expires” value in the HTTP response header to a time and date that has not yet expired, even though the “Expires” timestamp in the original header has already expired.

As yet another example, module 40 may remove a “No-cache” directive from the HTTP response header. More generally, module 40 may delete part or even all of the HTTP response header, so as to prevent app 36 from following cache directives specified in the header.

In another example, module 40 may add a “No-store” directive to the HTTP response header. Such an addition would indicate to app 36 to refrain from caching the content item in a local cache of the app, thereby avoiding double-caching (caching of a content item both in cache 52 and in the app's internal cache). This feature also causes app 36 to continue using the version of the content item cached in cache 52.

Further additionally or alternatively, header modification module 40 may modify HTTP response headers of cached content items in any other suitable way. In the context of the present patent application and in the claims, the terms “modifying cache directives” or “modifying a header” may comprise any kind of modification, e.g., modifying an attribute value of a cache directive, removing a cache directive, replacing a cache directive with another, and/or adding a cache directive in the header.

In various embodiments, header modification module 40 may modify the HTTP response header of a content item at various stages of the content delivery process. In some embodiments, module 40 modifies the header before the content item is placed in cache 52. The content item is then saved in cache 52 with the modified header. In other embodiments, module 40 modifies the header after the content item is retrieved from cache 52 and before it is served to app 36.

In yet other embodiments, module 40 modifies the header while the content item resides in cache 52, i.e., at any time between saving the content item in cache 52 and retrieving the content item from cache 52 for serving to app 36. The latter option may be useful, for example, when new information regarding validity, e.g., freshness status update, becomes available.

As described above, in some embodiments system 20 operates (vis-à-vis a certain user device 24) in a guaranteed prefetching mode at certain times. At other times, system 20 operates vis-à-vis this user device in a best-effort prefetching mode. In the guaranteed prefetching mode, prefetching subsystem 60 continuously tracks changes in content on content sources 28, and ensures that the content items cached in cache 52 are kept continuously synchronized with the corresponding up-to-date versions on the content sources.

As such, when operating in the guaranteed prefetching mode, subsystem 60 has a particularly high likelihood of possessing accurate validity information. Therefore, the combination of the disclosed header modification technique and the guaranteed prefetching mode is particularly effective. Nevertheless, the disclosed header modification technique is also applicable when operating in the best-effort prefetching mode.

In some embodiments, header modification module 40 performs header modifications when prefetching to the user device in question is in accordance with the guaranteed prefetching mode. In some embodiments, header modification module 40 performs header modifications only in the guaranteed prefetching mode, and not in the best-effort prefetching mode. In some embodiments, header modification module 40 decides whether to perform header modifications based, at least in part, on whether the current prefetching mode is the guaranteed prefetching mode or the best-effort prefetching mode.

In some scenarios, module 40 modifies the HTTP response header of some content item, thereby causing app 36 to use the content item, but the content item is actually not up-to-date. Such a scenario may occur, for example, in the best-effort prefetching mode (in which the validity information of the prefetching subsystem may sometimes be unreliable) or in the guaranteed prefetching mode (e.g., when a status report sent to the user device is lost). In such cases, processor 44 may still present the content item to the user, and in parallel re-evaluates the freshness of the content item. This feature is described, for example, in U.S. Patent Application Publication 2017/0111465, entitled “Freshness-aware presentation of content in communication terminals,” which is assigned to the assignee of the present patent application and whose disclosure is incorporated herein by reference.

As noted above, the disclosed techniques can be implemented using one or more processors, in the user device and/or on the network side. In an example non-limiting embodiment, some or all of the functionality of prefetch subsystem 60 and/or header modification module 40 may be implemented in one or more of the following:
In the user device Operating System (OS) running on processor 44.
In one of apps 36 that supports prefetching.
In an app, which runs on processor 44 and provides prefetching and caching services to one or more other apps 36.

In yet another example, header modification module 40 can be implemented as an integral part of prefetch subsystem 60, and not as a separate entity. By the same token, module 40 may be integrated with prefetch agent 48 in the same software module.

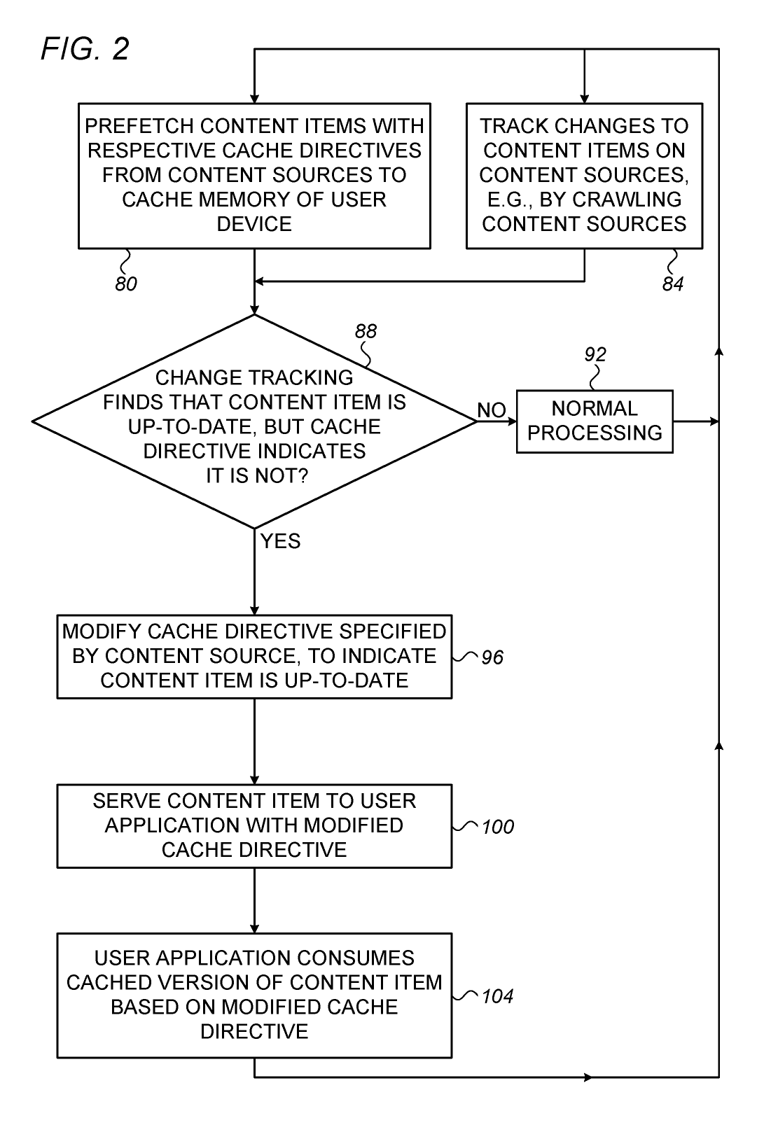

FIG. 2 is a flow chart that schematically illustrates a method for content prefetching, in accordance with an embodiment of the present invention. The method begins with prefetch subsystem 60 and/or prefetching agent 48 prefetching content items from content sources 28 to cache 52 of user device 24, at a prefetching step 80. At least some of the prefetched content items comprise cache directives specified by the originating content source. At a tracking step 84, prefetch subsystem 60 tracks changes to content items on content sources 28, e.g., by crawling the content.

At a checking step 88, prefetch subsystem 60 and/or prefetching agent 48 checks whether, for a certain content item cached in cache 52, the original cache directive indicates that the content item is not up-to-date, but the tracking process of step 84 indicates that the content item is in fact up-to-date.

If not, the content item is processed normally, at a normal processing step 92. In normal processing, when an app 36 requests the content item, agent 48 serves the content item from cache 52 along with the cache directives specified by the content source. The app processes the content item in accordance with the specified cache directives.

If, on the other hand, the tracking process indicates that the content item is up-to-date, even though the original cache directive indicates that the content item is not up-to-date, header modification module 40 modifies the HTTP response header of the content item, in a header modification step 96. Any of the header modification schemes described herein can be used.

At a modified serving step 100, module 40 or agent 48 serves the content item, with the modified header, to a requesting app 36. At a consumption step 104, the app consumes the cached version of the content item, in accordance with the modified header.

Although the embodiments described herein mainly address caching of prefetched content, the methods and systems described herein can also be used in other systems and applications that employ caching. The disclosed techniques can be used to enable any suitable caching system, which is able to provide improved caching instructions to apps (improved relative to the original cache directives), to provide such instructions without requiring any changes to the apps. Thus, for example, the disclosed method of modifying cache directives can be implemented in conjunction with a guaranteed cache status update mode and/or a best-effort cache status update mode described in U.S. Provisional Patent Applications 62/412,864 and 62/567,267, cited above.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An apparatus, comprising:
a network interface for communicating over a communication network; and
one or more processors, configured to:
prefetch content items over the communication network, from a content source to a cache memory of a user device, wherein at least a content item among the content items comprises a cache directive specified by the content source; and
modify the cache directive specified by the content source, and serve the content item having the modified cache directive to a user application running in the user device, so as to cause the user application to process the content item responsively to the modified cache directive.

2. The apparatus according to claim 1, wherein the cache directive is specified in a header of a message of an application-layer protocol in which the content item is prefetched, and wherein the processors are configured to modify the cache directive by modifying the header.

3. The apparatus according to claim 2, wherein the application-layer protocol comprises Hypertext Transfer Protocol (HTTP).

4. The apparatus according to claim 3, wherein the cache directive is selected from a group consisting of “max-age,” “expires” timestamp, “no-store” and “no-cache.”

5. The apparatus according to claim 1, wherein the cache directive specified by the content source indicates that the content item is not up-to-date, and wherein the processors are configured to modify the cache directive to indicate that the content item is up-to-date.

6. The apparatus according to claim 1, wherein the processors are configured to modify the cache directive only while operating in a guaranteed prefetching mode, and not while operating in a best-effort prefetching mode.

7. The apparatus according to claim 1, wherein the processors are configured to decide whether to modify the cache directive based, at least in part, on whether a current prefetching mode is a guaranteed prefetching mode or a best-effort prefetching mode.

8. The apparatus according to claim 1, wherein the processors are configured to present the prefetched content item to a user, and in parallel verify over the communication network whether the presented content item is up-to-date.

9. The apparatus according to claim 1, wherein the processors are configured to track changes to the content item on the content source, and to modify the cache directive based on the tracked changes.

10. The apparatus according to claim 1, wherein at least one of the processors is a processor of the user device.

11. The apparatus according to claim 10, wherein the processors are configured to modify the cache directive using, at least in part, a software component running in an operating system of the user device.

12. The apparatus according to claim 1, wherein at least one of the processors is a processor of a network-side node external to the user device.

13. The apparatus according to claim 12, wherein the processors are configured to modify the cache directive using, at least in part, a software component running in the network-side node.

14. The apparatus according to claim 1, wherein the processors are configured to modify the cache directive by removing the cache directive or removing at least part of a header of a message carrying the content item.

15. The apparatus according to claim 1, wherein the processors are configured to modify the cache directive by replacing the cache directive or replacing at least part of a header of a message carrying the content item.

16. The apparatus according to claim 1, wherein the processors are configured to modify the cache directive by adding, to a header of a message carrying the content item, a “no-store” or “no-cache” cache directive.

17. The apparatus according to claim 1, wherein the processors are configured to modify the cache directive before caching the prefetched content item in the cache memory of the user device.

18. The apparatus according to claim 1, wherein the processors are configured to modify the cache directive while the prefetched content item resides in the cache memory of the user device.

19. The apparatus according to claim 1, wherein the processors are configured to modify the cache directive upon retrieving the prefetched content item from the cache memory of the user device for serving to the user application.

20. A method, comprising:
prefetching content items over a communication network, from a content source to a cache memory of a user device, wherein at least a content item among the content items comprises a cache directive specified by the content source; and
modifying the cache directive specified by the content source, and serving the content item having the modified cache directive to a user application running in the user device, so as to cause the user application to process the content item responsively to the modified cache directive.

21. The method according to claim 20, wherein the cache directive is specified in a header of a message of an application-layer protocol in which the content item is prefetched, and wherein the processors are configured to modify the cache directive by modifying the header.

22. The method according to claim 21, wherein the application-layer protocol comprises Hypertext Transfer Protocol (HTTP).

23. The method according to claim 22, wherein the cache directive is selected from a group consisting of “max-age,” “expires” timestamp, “no-store” and “no-cache.”

24. The method according to claim 20, wherein the cache directive specified by the content source indicates that the content item is not up-to-date, and modifying the cache directive comprises indicating by the cache directive that the content item is up-to-date.

25. The method according to claim 20, wherein modifying the cache directive is performed only while operating in a guaranteed prefetching mode, and not while operating in a best-effort prefetching mode.

26. The method according to claim 20, and comprising deciding whether to modify the cache directive based, at least in part, on whether a current prefetching mode is a guaranteed prefetching mode or a best-effort prefetching mode.

27. The method according to claim 20, and comprising presenting the prefetched content item to a user, and in parallel verifying over the communication network whether the presented content item is up-to-date.

28. The method according to claim 20, wherein modifying the cache directive comprises tracking changes to the content item on the content source, and modifying the cache directive based on the tracked changes.

29. The method according to claim 20, wherein modifying the cache directive is performed, at least in part, using a software component running in an operating system of the user device.

30. The method according to claim 20, wherein modifying the cache directive is performed, at least in part, by a network-side node external to the user device.

31. The method according to claim 20, wherein modifying the cache directive comprises removing the cache directive or removing at least part of a header of a message carrying the content item.

32. The method according to claim 20, wherein modifying the cache directive comprises replacing the cache directive or replacing at least part of a header of a message carrying the content item.

33. The method according to claim 20, wherein modifying the cache directive comprises adding, to a header of a message carrying the content item, a “no-store” or “no-cache” cache directive.

34. The method according to claim 20, wherein modifying the cache directive is performed before caching the prefetched content item in the cache memory of the user device.

35. The method according to claim 20, wherein modifying the cache directive is performed while the prefetched content item resides in the cache memory of the user device.

36. The method according to claim 20, wherein modifying the cache directive is performed upon retrieving the prefetched content item from the cache memory of the user device for serving to the user application.
